(19) United States
(12) Patent Application Publication
(10) Pub. No.: US 2011/0249736 A1
(43) Pub. Date: Oct. 13, 2011

(54) Codeword restriction for high performance video coding

(75) Inventors: Christopher A. Segall, Camas, WA (US); Jie Zhao, Camas, WA (US)

(73) Assignee: Sharp Laboratories of America, Inc.

(21) Appl. No.: 12/798,709

(22) Filed: Apr. 9, 2010

(51) Int. Cl. H04N 7/12

(52) U.S. Cl. 375/240.12; 375/E07.027

(57) ABSTRACT

A system for encoding and/or decoding video that includes the use of restricted codewords. The use of restricted codewords permits a reduction in the bit-rate of the video bit stream without substantially impacting the resulting image quality.

### CROSS-REFERENCE TO RELATED APPLICATIONS

Not applicable.

### BACKGROUND OF THE INVENTION

The present invention relates generally to a video encoder and/or a video decoder.

The transmission of video across a network typically includes a video encoder and a video decoder. The encoding of the video includes a lossy compression technique to achieve a lower bit rate for transmission while still providing a perceptually good video quality. By way of example, digital video discs used a MPEG-2 video compression standard, hereby incorporated by reference in its entirety.

Video compression typically operates based upon the grouping of neighboring pixels together, generally referred to as macroblocks. A macroblock, or other group of pixels, are compared from one frame to another frame, where the differences between the frames are transmitted. In the presence of motion, the video compression transmits data indicative of the motion of the macroblock, or other group of pixels, from one frame to another frame together with the differences between the frames.

H.264/AVC (formally known as ISO/IEC 14496-10-MPEG-4 Part 10, Advanced Video Coding) video compression standard, hereby incorporated by reference herein in its entirety, is used for many applications, such as Blu-ray discs. The H.264 standard is a block based compression standard that typically results in good video quality at substantially lower bit rates than MPEG-2.

While the H.264 standard provides a good result there is a desire for ever increasing reduction in the bit rate, especially for high definition content, while not significantly decreasing the perceived image quality.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a video encoder.

FIG. 2 illustrates a video decoder.

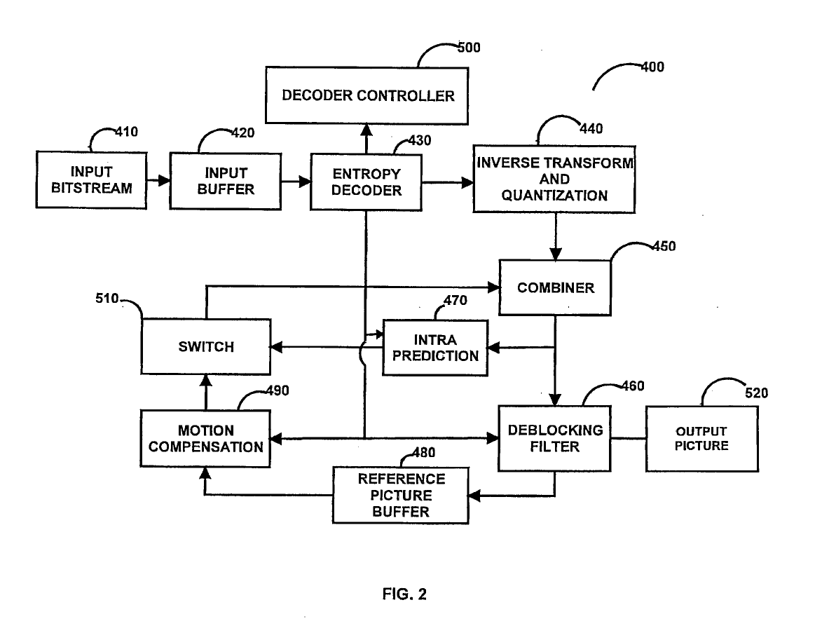

FIG. 3 illustrates a codeword video encoding technique.

FIG. 4 illustrates a process for codeword restriction.

### DETAILED DESCRIPTION OF PREFERRED EMBODIMENT

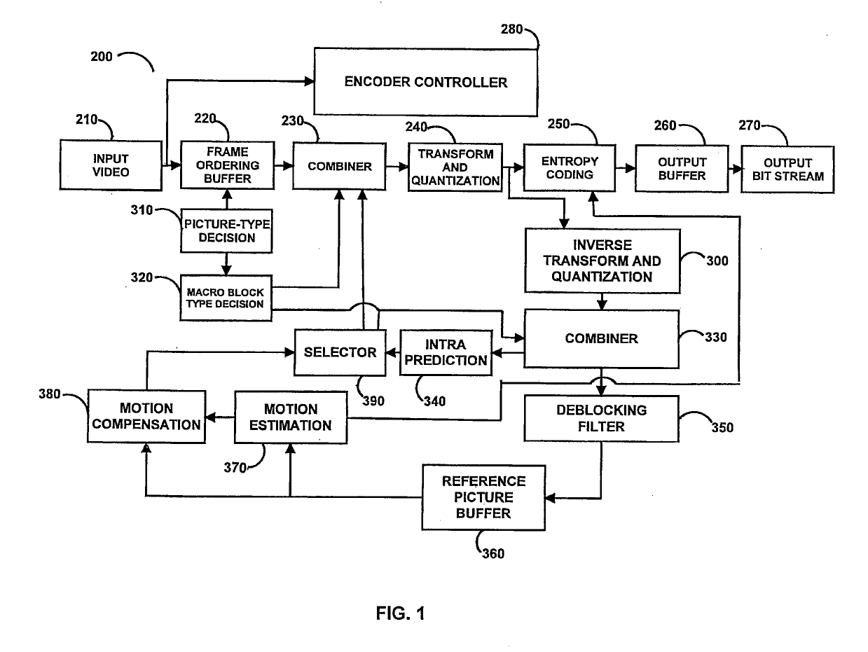

Referring to FIG. 1, an exemplary H.264 encoder 200 is described for purposes of illustration. It is to be understood that any video encoder may be used. The input video 210 is provided to a buffer suitable to reorder frames, or portions thereof, as necessary 220. A combiner 230 modifies a portion of the suitable reordered frame in a manner suitable for a transform and quantization process 240. The transform and quantization process 240 provides a signal to an entropy coder 250. The entropy coder 250 provides a signal to an output buffer 260 for the output bit stream 270. An encoder controller 280 that receives the input video 210 provides control signals to all the modules of the encoder 200.

The transform and quantization process 240 also provides its output to an inverse transform and quantization 300 so that the corresponding decoder can be simulated. A picture-type decision process 310 is interconnected with the frame ordering buffer 220. The picture-type decision process 310 is also interconnected to a macro-block-type decision 320. In this manner, control over the frame ordering buffer 220 may be achieved. In addition, control over the type of macro-block may be achieved.

The inverse transform and quantization 300 provides a signal to a combiner 330, which in combination with the macro-block type decision 320, provides a signal to an intra coding prediction module 340 and a deblocking filter 350. The deblocking filter 360 is interconnected to a reference picture buffer 360. The reference picture buffer 360 provides a signal to a motion estimation process 370 and a motion compensation process 380. The motion estimation 370 provides a signal to the motion compensation 380 and to the entropy coder 250. A selector 390 selects between the output of the motion compensation 380 and the output of the intra-coded prediction 340 for the combiner 230. In this manner, the combiner 230 receives information related to whether the macro-block is intra coded 340 or motion-compensation coded 380.

The decision made by the selector 390 relates to the macro-block type decision 320. For example, if the macro-block type decision 320 decides that the macro-block should be intra-coded, then the selector should select a form of intra-prediction. For example, if the macro-block type decision 320 decides that the macro-block should be motion compensated, then the selector should select a form of motion compensation. The decisions made by the macro-block type decision 320, the picture-type decision 310, the selector 390, and the selection among one or more intra-prediction techniques 340, are all included within the bit-stream by the entropy coding 250. In addition, the combiner 330 may receive an input from the selector 390 to provide information about the selection made.

Any suitable decoder may be used. An exemplary video decoder 400 for an input bit stream 410 includes an input buffer 420. The input buffer 420 provides a signal to an entropy decoder 430. The entropy decoder 430 provides a signal to an inverse transform and quantization process 440. The inverse transform and quantization process 440 provides a signal to a combiner 450. The combiner 450 provides a signal to a deblocking filter 460 and an intra-prediction module 470. The deblocking filter 460 provides a signal to a reference picture buffer 480. The reference picture buffer 480 provides a signal to a motion compensator 490.

The entropy decoder 430 provides a signal to the motion compensation 490 and the deblocking filter 460. The entropy decoder 430 also provides a signal to a decoder controller 500. The decoder controller is interconnected with the other modules of the decoder 400. The motion compensator 490 provides a signal to a switch 510. The intra-prediction module 470 provides a signal to the switch 510. The switch 510 selectively provides a signal to the combiner 450. The deblocking filter 460 provides an output picture 520.

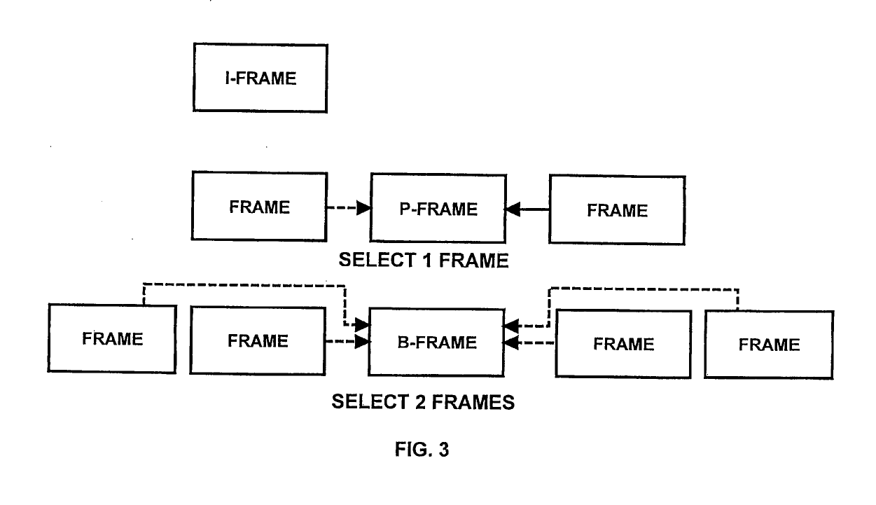

Referring to FIG. 3, different frames, or portions thereof, of video are typically encoded using different techniques. One such technique includes the use of picture types generally referred to as I-frames, P-frames, and B-frames. I-frames do not require other video frames to decode. P-frames may use data from a previously transmitted frame to decode. B-frames may use two or more previously transmitted frames to decode. The encoding of the video may likewise be based upon one or more different sized blocks of pixels from within the frame. Also, the encoding of the video may likewise be based upon motion estimation, slices, spatial prediction of blocks, or otherwise between one or more frames. Therefore, in general there is decoder prediction information transmitted with the video bitstream which indicates the type of encoding of the frames, the type of prediction of the frames, the direction(s) of the predictions, which frames are used, motion estimation information between the frames, frame size information, block sizing information within the frame, spatial prediction information, and/or other suitable parameters. Accordingly, the decoder 400 decodes the frames of the video based upon the prediction information provided with the bit-stream by the encoder 200.

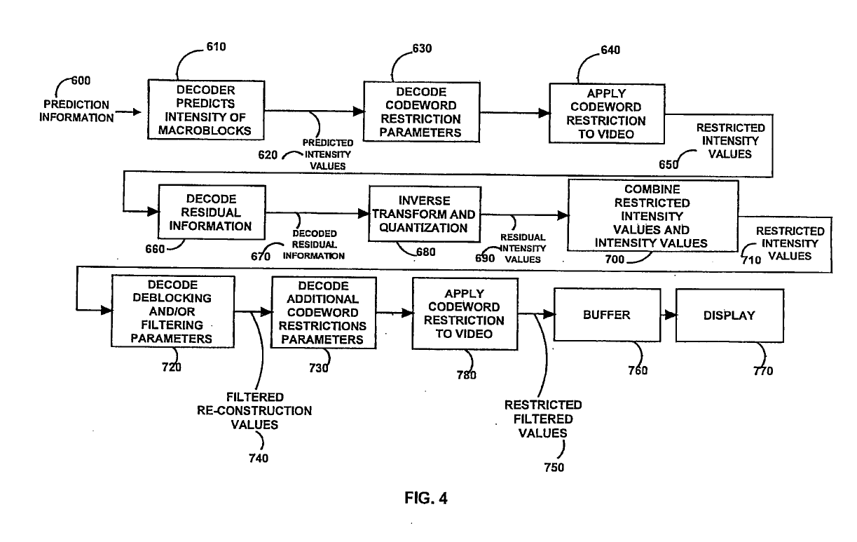

Referring to FIG. 4, based upon the prediction information 600, the decoder 400 predicts the intensity of the macroblocks (or other regions of the image) 610. The predicted values may be generally referred to as predicted intensity values 620.

In many cases, the range of desirable values for a particular application may be different than the range of values resulting from the prediction information 600 determining the predicted intensity values 620. For example, it may be desirable to have a smaller range of code values, a larger range of code values, a minimum code value, a maximum code value, and/or a shifted range of code values than the predicted intensity values 620. In addition, it may be desirable to only have selected values within a range of code values. These are generally referred to herein as codeword restriction parameters 630, merely for purposes of identification, and are decoded. The codeword restriction parameters may correspond to any portion of the video, such as for example, the sequence, the picture, the slice, the block, or the pixel. In one such example, different codeword restriction parameters may correspond to portions of a video sequence that contain a combination or video sources. Video sequences composed of a mixture of computer graphics, broadcast video and text may have different codeword restriction parameters assigned to the graphics, broadcast video and text regions, respectively. These regions may appear spatially within frames of the video sequence or temporally throughout the video sequence. In addition, different codeword restriction parameters may correspond to portions of a video sequence that contain a combination of different visual elements. Video sequences that are composed of a mixture of sky, complex texture, and dark features may have different codeword restriction parameters assigned to the sky, complex texture and dark feature regions, respectively. These regions may appear spatially within frames of the video sequence or temporally throughout the video sequence.

At the decoder, the codeword restriction process may be applied 640 using many different techniques. One suitable technique is using a clipping operation. Another suitable technique is using a projection operator that maps each input code value to a suitable output code value that is a member of the restricted set of codewords. In many cases, a distance measure is used to select the output code value from the restricted set of codewords when the projection is not one of the codewords. Another suitable technique is using a projection operator that maps each combination of input code values (e.g., luminance and colors for a pixel) to a suitable combination of output code values that are a member of the restricted set of codewords. In many cases, a distance measure is used to select the output combination of code values from the restricted set of codewords when the projection is not one of the codewords. For cases where an input code value may have the same distance between multiple allowable code values, additional metrics may be used to determine the output code value. For example, the output code value may be defined as the smallest value in the set of allowable code values that have a minimum distance to the input code value. In another example, the output code value may be defined as the largest value in the set of allowable code values that have a minimum distance to the input code value.

At the encoder, the codeword creation process may determine a set of restricted code values by creating a histogram of the code values (or any other technique) based on the original image data (or other data). In one example, the restricted code values may be selected by identifying the maximum and the minimum code values that occur in the image data (or otherwise). In another example, the restricted code values may be selected by identifying the code value histogram counts greater than a threshold, such as zero. The encoder may analyze the original image data (or otherwise) and separate it into partitions of image data. The restricted code words for each partition are determined, and the partition information and corresponding restricted code values are provided together with the bit-stream to the decoder. At the decoder, the partition information may be extracted from the bit-stream and the decoder then decodes the partitions using the signaled (and possibly different) set of restricted code values. In one embodiment, the encoder may identify graphical elements within the image frame as a first partition. In another embodiment, the encoder may identify moving text within the image data as a first partition. Accordingly, portions of the image may be encoded with a different degree of image quality than other portions of the image, at least in part, based upon a suitable selection of restricted code values.

Based upon the decoded restricted codewords, the decoder may generate a block (or set) of restricted intensity values 650. The decoder likewise decodes residual information 660 from the bit stream to create decoded residual information 670 and thereafter creates a set of residual intensity values 690 by performing inverse transform and quantization 680 of the decoded residual information 670. The restricted intensity values 650 are combined 700 with the residual intensity values 690 to create a block (or set) of reconstructed intensity values 710. This process is repeated for the remaining blocks (or otherwise) for the frame or portion thereof. Deblocking and/or filtering parameters are decoded 720 from the bit-stream, and additional codeword restriction parameters are decoded 730 from the bit-stream suitable for use with the deblocking and/or filtering parameters 720. The deblocking and/or filter parameters 720 are applied to the frame, or frame portion thereof, of reconstructed intensity values 710 to obtain filtered reconstructed values 740. The filtered reconstructed values 740 are mapped to the decoded additional restricted codewords 730 related to the deblocking and/or filter parameters to obtain restricted filtered values 750. The restricted filtered values 750 then may be buffered 760 for future prediction and/or otherwise provided to a display 770. It is to be understood that the particular order of processing depicted in FIG. 4 is exemplary. The order of processing may be modified, as desired. For example, the codeword restriction may be performed after the combining 700. For example, the codeword restriction may be performed within a process, such as the prediction of macro blocks 610 when bi-direction prediction is enabled. In the case of B-frames, two motion compensated predictions may be processed by the codeword restriction operation before being combined to generate a prediction.

For the different components of a color signal the ranges may likewise be selected differently, as desired. By way of example, it may be desirable for luma components to be restricted to the range of 16-235 and the chroma values to be restricted to the range of 16-240. Another example includes a minimum and maximum value being received for the luma component, and a second minimum and maximum value being received for the chroma components. As another example, a minimum and maximum value are received for a first luma component, a minimum and maximum value are received for a first chroma component, and a minimum and maximum value are received for a second luma component, typically used in conjunction with YCbCr encoding.

The codeword restriction parameter may be identified using many different techniques. In one embodiment, the codeword restrictions may be explicitly provided to the decoder within the video bit stream (or an auxiliary bit stream associated with the video bit stream). In some cases, the explicitly provided codewords may be a list of predefined length, the explicitly provided codewords may include all the acceptable values, and/or the length of a list together with a list of values. For example, the codeword restriction parameter may contain the values [0 128 256] when the length of the list is predefined to be three. In this example, the acceptable values are [0 128 256]. As a second example, the codeword restriction parameter may contain the values [5 0 64 128 196 255], where the length of the list is defined to be equal to the first value (5). In this example, the acceptable values are [0 64 128 196 255]. In other cases, the codeword restriction parameter may consist of a bit-mask that denotes the allowable code values. One example of a bit-mask contains N bits where N=2̂M, where M is the bit-depth of the output of the reconstruction operation. Another example of a bit-mask contains N/Z bits where N=2̂M and Z is a decimation factor. Preferably the codeword restriction operation would restrict the output of the operator divided by Z to be in the signaled set. In one example, the allowable values are defined by the expression bitmask(reduce(value/Z))=1, where bitmask(i) denotes the value of the i-th component of the bit-mask and reduce(A) maps the value A to an integer output value. For example, in the case that the reduce(A) operation maps A to the integer component of A, M=8, Z=32, the bit-mask [0 1 0 0 0 0 0 0] would define that the set of allowable values is [32,63]. In a second example, in the case that the reduce(A) operation maps A to the integer component of A, M=8, Z=64, the bit-mask [0 0 0 1] would define that the set of allowable values is [192,255].

The codeword restriction parameter may consist of a list of allowed code vectors. Each element in the code vector may contain multiple code values (e.g., three), where the code values describe a luma code value, and two chroma code values.

In another embodiment, the codeword restrictions may be identified by a flag within the video bit stream (or an auxiliary bit stream associated with the video bit stream). In one technique the codeword restriction parameter may consist of one or more flags signaling where the codeword restriction operation is performed. For example, the flag may signal if the restriction operation should follow an adaptive interpolation filter (e.g., a motion compensation filter) and/or should follow an adaptive loop filter (e.g., a deblocking filter). For example, the flag may signal if the restriction operation should be applied when a specific process is enabled. One such process is whether the codeword restrictions are to be applied based upon whether an adaptive loop filter is used. Another such process is whether the codeword restrictions are to be applied to the output of an adaptive loop filter. Another such process is whether the codeword restriction operation should operate on the output pixels of an adaptive interpolation filter that is processed by a default filter. For example, if the system uses a first interpolation technique for some pixels within the current image frame and a second interpolation technique for other pixels within the current image frame, the flag may indicate to apply the codeword restriction operation only to pixels that are processed by the second interpolation technique. By way of illustration, the first interpolation technique may be a default technique and the second interpolation technique may be an adaptive interpolation technique. Another such process is whether the codeword restriction operation should operate on the output pixels of an adaptive loop filter that is processed by a default filter. For example, if the system uses a first loop filter technique for some pixels within the current image frame and a second loop filter technique for other pixels within the current image frame, the flag may indicate to apply the codeword restriction operation only to pixels that are processed by the second loop filter technique. By way of illustration, the first loop filter technique may be a default technique and the second loop filter technique may be an adaptive loop filter technique.

The codeword restriction parameters 630 used for determining the intensity values and the additional codeword restriction parameters 730 used on the filtered image may be the same or different. In addition the codeword restriction parameters 630 and additional codeword restriction parameters 730 may be different. The codeword restriction parameters 630 are tuned to be most effective when applied to the predicted intensity values. The additional codeword restriction parameters 730 are tuned to be most effective when applied to deblocking and/or filtered images. In this manner, the different restriction parameters may be more effective. In some embodiments, both of the codeword restriction parameters may be provided together at the same general position, or otherwise jointly encoded, within the bit-stream. In other embodiments, both the codeword restriction parameters may be separated from one another within the bit stream.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for decoding video comprising:
(a) receiving prediction information for decoding a bit stream together with encoded said video;
(b) receiving codeword restriction parameters together with said video;
(c) decoding said video based upon said prediction parameters;
(d) modifying said decoded video based upon said codeword restriction parameters to modify the selection of codewords representing said video.

2. The method of claim 1 wherein said prediction information indicates a frame is intra-coded frame encoded.

3. The method of claim 1 wherein said prediction information indicates a frame is coded based upon a previously transmitted frame.

4. The method of claim 1 wherein said prediction information indicates a frame is coded based upon two previously transmitted frames.

5. The method of claim 1 wherein said prediction information indicates different size groups of pixels within said video being encoded separately.

6. The method of claim 1 wherein said prediction information indicates motion estimation.

7. The method of claim 1 wherein said prediction information indicates spatial prediction of groups of pixels.

8. The method of claim 1 wherein said codeword restriction parameters is a flag indicating use of codeword restrictions.

9. The method of claim 1 wherein said codeword restriction parameters is a smaller range of codewords than would have otherwise been used without said codeword restriction.

10. The method of claim 1 wherein said codeword restriction parameters is a larger range of codewords than would have otherwise been used without said codeword restriction.

11. The method of claim 1 wherein said codeword restriction parameters is a different range of codewords than would have otherwise been used without said codeword restriction.

12. The method of claim 1 wherein said modifying said decoded video based upon said codeword restriction parameters is a clipping operation.

13. The method of claim 1 wherein said modifying said decoded video based upon said codeword restriction parameters is a mapping operation.

14. The method of claim 1 wherein said mapping operation further includes use of a distance measure to select a suitable codeword.

15. The method of claim 1 wherein said modifying said decoded video based upon said codeword restriction parameters is a mapping operation between a set of input code values and a set of output code values.

16. The method of claim 15 wherein said set of output code values is representative of a luminance, a first chrominance, and a second chrominance.

17. The method of claim 1 wherein said codeword restriction parameters include a first codeword restriction for a first part of a frame of said video and a second codeword restriction for a second part of a frame of said video.

18. The method of claim 1 wherein said codeword restriction parameters include a bit mask.

19. The method of claim 1 wherein said codeword restriction parameters are selectively applied.

20. The method of claim 19 wherein said selective application is based upon an adaptive interpolation filter.

21. The method of claim 19 wherein said selective application is based upon an adaptive loop filter.

22. The method of claim 19 wherein said selective application is based upon using a default filter.
